(19) United States
(12) Patent Application Publication
(10) Pub. No.: US 2015/0309962 A1
(43) Pub. Date: Oct. 29, 2015

(54) METHOD AND APPARATUS FOR MODELING A POPULATION TO PREDICT INDIVIDUAL BEHAVIOR USING LOCATION DATA FROM SOCIAL NETWORK MESSAGES

(71) Applicant: Xerox Corporation, Norwalk, CT (US)

(72) Inventors: MOSHE LICHMAN, Irvine, CA (US); Wei Peng, Fremont, CA (US); Tong Sun, Penfiled, NY (US); Ming Yang, Fairport, NY (US)

(73) Assignee: Xerox Corporation, Norwalk, CT (US)

(21) Appl. No.: 14/262,391

(22) Filed: Apr. 25, 2014

(51) Int. Cl. G06F 17/18; H04L 29/08; H04L 12/58

(52) U.S. Cl. CPC G06F 17/18; H04L 51/32; H04L 67/22

(57) ABSTRACT

A method, non-transitory computer readable medium, and apparatus for predicting a location behavior of at least one individual are disclosed. For example, the method receives a plurality of social networking messages having spatial location data and user identification information, filters the plurality of social networking messages to remove one or more of the plurality of social networking messages that are not related to mobility of a user to create a filtered plurality of social networking messages, creates a population model by applying a kernel density estimation to the filtered plurality of social networking messages, creates an individual model for each different user identification by applying the kernel density estimation to a subset of the filtered plurality of social networking messages for the each different user identification and generates a probability density function map that predicts the location behavior of the at least one individual.

The present disclosure relates generally to modeling a population and predicting the behavior of individual or groups within the population and, more particularly, to a method and apparatus for predicting individual behavior using a population model created from social network messages.

### BACKGROUND

Currently, population modeling only provides general information about an entire population that is modeled. However, predictions about individuals within the population cannot be made, or is very difficult to make accurately, using the general population model.

One reason may be because the amount of data for each individual may be sparse or nonexistent. Thus, making predictions on a location of an individual where data is sparse or does not exist would typically be inaccurate or assumed to be zero.

Some methods attempt to provide predictions on individual behavior without general population modeling. However, these methods are generally applied to individuals that have perfect data sets (i.e., a large number of data points on the individual to model and predict the individual's behavior and location). In addition, these models typically are based on a discrete location (e.g., a specific store, restaurant, landmark, and the like) rather than continuous spatial coordinates.

### SUMMARY

According to aspects illustrated herein, there are provided a method, a non-transitory computer readable medium, and an apparatus for predicting a location behavior of at least one individual. One disclosed feature of the embodiments is a method that receives a plurality of social networking messages having spatial location data and user identification information, filters the plurality of social networking messages to remove one or more of the plurality of social networking messages that are not related to mobility of a user to create a filtered plurality of social networking messages, creates a population model by applying a kernel density estimation to the filtered plurality of social networking messages, creates an individual model for each different user identification by applying the kernel density estimation to a subset of the filtered plurality of social networking messages for the each different user identification and generates a probability density function map that predicts the location behavior of the at least one individual using a mixture model based upon the individual model of the at least one individual and the population model.

Another disclosed feature of the embodiments is a non-transitory computer-readable medium having stored thereon a plurality of instructions, the plurality of instructions including instructions which, when executed by a processor, cause the processor to perform an operation that receives a plurality of social networking messages having spatial location data and user identification information, filters the plurality of social networking messages to remove one or more of the plurality of social networking messages that are not related to mobility of a user to create a filtered plurality of social networking messages, creates a population model by applying a kernel density estimation to the filtered plurality of social networking messages, creates an individual model for each different user identification by applying the kernel density estimation to a subset of the filtered plurality of social networking messages for the each different user identification and generates a probability density function map that predicts the location behavior of the at least one individual using a mixture model based upon the individual model of the at least one individual and the population model.

Another disclosed feature of the embodiments is an apparatus comprising a processor and a computer readable medium storing a plurality of instructions which, when executed by the processor, cause the processor to perform an operation that receives a plurality of social networking messages having spatial location data and user identification information, filters the plurality of social networking messages to remove one or more of the plurality of social networking messages that are not related to mobility of a user to create a filtered plurality of social networking messages, creates a population model by applying a kernel density estimation to the filtered plurality of social networking messages, creates an individual model for each different user identification by applying the kernel density estimation to a subset of the filtered plurality of social networking messages for the each different user identification and generates a probability density function map that predicts the location behavior of the at least one individual using a mixture model based upon the individual model of the at least one individual and the population model.

### BRIEF DESCRIPTION OF THE DRAWINGS

The teaching of the present disclosure can be readily understood by considering the following detailed description in conjunction with the accompanying drawings, in which:

FIG. 1 illustrates an example block diagram of a communication network of the present disclosure;

FIG. 2 illustrates an example probability density function map;

FIG. 3 illustrates an example flowchart of one embodiment of a method for predicting a location behavior of at least one individual; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for predicting a location behavior of at least one individual. As discussed above, currently used methods to model individual location behavior require a perfect data set for the individual (e.g., a large amount of data in various different locations) and require discrete locations (e.g., a specific store, building, landmark, and the like) that are represented as a single dimension as opposed to a spatial location comprising two dimensions (e.g., x and y coordinates). Current methods cannot accurately provide location behavior or location prediction for an individual when there is sparse or no data available for the individual.

One embodiment of the present disclosure addresses this problem by providing a method to predict location behavior of an individual even when there is little to no location data available for the individual. One embodiment of the disclosure uses a mixed model that combines modeling of an overall population of an area and the modeling of the individual. In one embodiment, when location data for an individual is sparse making predicting the individual's possible future locations difficult, the mixed model may “borrow” or infer the individual's possible future location based on the modeling of the overall population.

In other words, the mixed model may still provide a probability that an individual may be at a location even when no data was ever previously received indicating that the individual was at the location. Previous models would compute a probability of zero in the above example. However, using the mixed model of the present disclosure, the mixed model may be able to still compute a probability based on tendencies of the overall population.

In addition, the prediction of an individual's location behavior may be leveraged for other applications. For example, the prediction of an individual's location behavior may be used for different types of event detection (e.g., fraud detection). Other applications of the prediction of an individual's location behavior may be combining a prediction of a plurality of different individual's location behavior to be used for city planning (e.g., determining where roads should be added, public transportation should be added, where additional electrical grids, gas lines, and the like, should be added, and so forth).

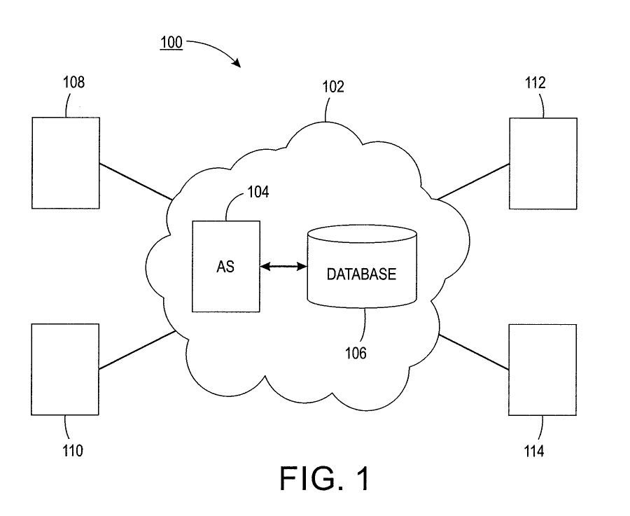

FIG. 1 illustrates an example communication network 100 of the present disclosure. In one embodiment, the communication network 100 may include an Internet Protocol (IP) network 102 and one or more mobile endpoint devices 108, 110, 112 and 114. In one embodiment, the IP network 102 may include an application server (AS) 104 and a database (DB) 106. The IP network 102 may be part of a service provider's network that provides location behavior prediction services.

It should be noted that the IP network 102 has been simplified for ease of description of the present disclosure. The IP network 102 may include one or more additional access networks (e.g., cellular access networks, broadband access networks, and the like) and one or more additional network elements (e.g., firewalls, border elements, gateways, and the like) that are not shown in FIG. 1.

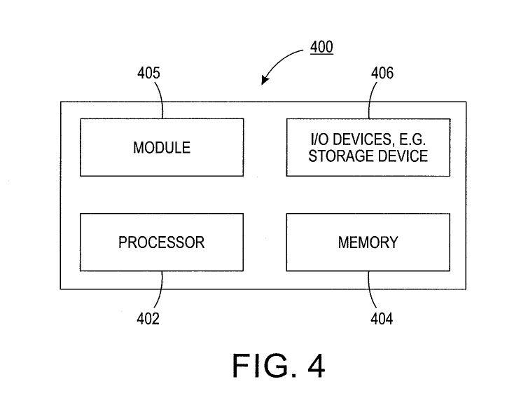

In one embodiment, the AS 104 may be deployed as a hardware application server or (e.g., a general purpose computer described below in FIG. 4). The AS 104 may perform the various functions and methods described herein. In one embodiment, the DB 106 may be used to store a plurality of social network messages received from the mobile endpoint devices 108-114 and used to store modeling algorithms and the resulting prediction values, as discussed below. The DB 106 may also be used store any generated probability density function maps, models, user identification information, and the like, as discussed below.

In one embodiment, the mobile endpoint devices 108-114 may be any type of mobile endpoint device capable of transmitting a social networking message via either a wired or wireless connection. For example, the mobile endpoint device 108 may be a laptop computer, a smartphone, a mobile telephone, a tablet computer, and the like. Although a single AS 104, a single DB 106 and four mobile endpoint devices 108-114 are illustrated in FIG. 1, it should be noted that any number of application servers, databases and mobile endpoint devices may be deployed in the communication network 100.

As noted above, the mobile endpoint devices 108-114 may transmit social networking messages. In one embodiment, the social networking messages may be any type of social networking messages that include spatial coordinate data and user identification data. In one embodiment, the social networking messages may be, for example, “tweets” transmitted by users that use Twitter®. The spatial coordinate data may include Global Positioning System (GPS) coordinate data (e.g., x, y coordinates of a map or a region). In other words, the spatial coordinate data is not a discrete location (e.g., a one dimensional value that only provides a name of a restaurant or a store, a building, a landmark, and the like) typically used by other methodologies.

In one embodiment, the user identification data may be used to group the social network messages based on each one of a different plurality of users or individuals. The different groups of social network messages for the different plurality of users or individuals may be used to create an individual model and predict location behavior of each individual, as discussed below.

In one embodiment, the social networking messages may be used to create a population model and an individual model for each one of the different users. In one embodiment, to create the population model and the individual model the plurality of social networking messages may be filtered to create a filtered plurality of social networking messages that relate to mobility of the users. In other words, the plurality of social networking messages may be filtered to remove one or more of the plurality of social networking messages that are not related to mobility of the user.

In one embodiment, the plurality of social networking messages may be filtered to remove a first one or more of the plurality of social networking messages that are from stationary bots. For example, stationary bots may be from a stationary location that does not represent an individual (e.g., a news cast, a weather report, or other stationary reports).

In one embodiment, the plurality of social networking messages may be filtered to combine a second one or more of the plurality of social networking messages that are from a user within a predefined time period (e.g., within 30 minutes, an hour, and the like) and within a predefined distance (e.g., within 1 mile, 50 meters, and the like). For example, some social networking messages may be part of a conversation between two or more individuals. Thus, these types of social networking messages may be within a predefined time period (e.g., an hour) and within a predefined distance (e.g., 20 meters) of one another. These types of social networking messages do not help capture individual mobility, and therefore, may be combined as a single social networking message within the filtered plurality of social networking messages.

In one embodiment, the plurality of social networking messages may be filtered to remove a third one or more of the plurality of social networking messages that are from a weekend. For example, an assumption may be made that during weekdays mobility patterns of individuals are more observable.

It should be noted that the social networking messages may be filtered to remove other types of messages not related to mobility of the user that is not described above. In addition, any one or more of the filters described above may be used alone or in any number of different combinations to create the filtered plurality of social networking messages.

A mathematical model may then be applied to the filtered plurality of social networking messages to create a population model and an individual model. In one embodiment, the mathematical model may be a kernel density estimation. However, it should be noted that other mathematical models may be used (e.g., a multivariate Gaussian model).

In one embodiment, the kernel density estimation applied to the filtered plurality of social networking messages may be represented by Equation (1) below:

$$pdf ( x ) = \frac{1}{n} {\sum }_{i = 1}^{n} {K}_{H} ( x - {x}_{i} ) , n = \vert D \vert , \qquad Equation ( 1 )$$

wherein pdf(x) is a probability density function of a location vector x comprising (x,y) coordinates (e.g., the spatial location data contained in the social networking message), K_{H} is a kernel function of the location vector x and an individual location vector xᵢ and |D| is a total number of the filtered plurality of social networking messages.

In one embodiment, the kernel function K_{H} may be defined by Equation (2) below:

$${K}_{H} ( x ) = {\vert H \vert}^{- 0.5} * {( 2 π )}^{- \frac{d}{2}} {e}^{- \frac{1}{2} {x}^{T} {H}^{- 0.5} x} , \qquad Equation ( 2 )$$

wherein H represents a bandwidth on each dimension, d, of a density of each training data point (e.g., the filtered social networking messages) and T represents a transpose function.

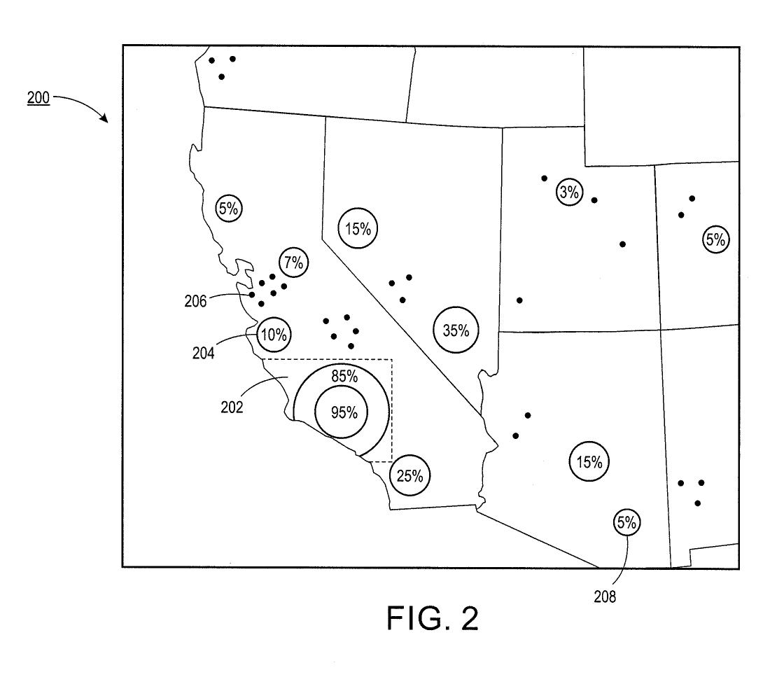

Using, the population model and the individual models calculated using the kernel density estimation model described by Equations (1) and (2) above, predictions of location behavior of an individual may be made using a mixture model. The location behavior may be defined as a probability value that an individual will be at a particular location. In one embodiment, the probabilities of all the various locations that are considered may be illustrated in a probability density function map 200 as illustrated in FIG. 2.

FIG. 2 illustrates one example of the probability density function map 200 for an individual. In one example, the prediction of the individual being at a particular location at a future time may be presented as a probability value or a percentage value 204. In one embodiment, only those probability values greater than a threshold (e.g., greater than 1%) may be illustrated on the map 200. In one embodiment, those locations having a probability value less than 1% may be illustrated with dots 206 that do not display a value. In another embodiment, the probability density function map 200 may be a series of concentric contour lines that indicate a lower probability value for contour line that is further away from the region 202.

In one embodiment, the predictions of location behavior of an individual may be made over a continuous spatial area. In other words, the predictions are not restricted to a discrete location, such as for example, a particular restaurant, store, building or landmark. In addition, predictions may be made for locations that the individual may not have any data for outside of a region 202 that the data or the plurality of social networking messages was collected from.

For example, previous methods may not be able to provide a prediction for an individual at a particular location if there is no data for the individual. Typically, the prediction would be zero or inaccurate. At best, the previous methods would only be able to provide a prediction of a discrete location within the region 202 that the data was collected from. However, embodiments of the present disclosure allow predictions on location behavior of an individual to be made over a continuous spatial location even for locations outside of the region 202 that the data was collected from and for locations that have no data associated with the individual by inferring data from other individuals within a general population model.

In one embodiment, the mixture model used to generate the probability density function map 200 may be illustrated in Equation (3) below:

pdf(xᵢ)=α*Model_{D}_{ᵢ}+(1−α)*Model_{D}, Equation (3):

wherein α is a value that varies based upon a number of filtered social networking messages available for an individual, Model_{D}_{ᵢ} represents the individual model created by the kernel density estimation and Model_{D} represents the population model created by the kernel density estimation.

In other words, Equation (3) illustrates how the weighting of the individual model and the population model may change as the value of α changes depending on a number of social networking messages available for an individual. Table 1 below illustrates one example of how the value of a may vary given a different number of social networking messages available for an individual.

TABLE 1
α VALUES FOR # OF POINTS

| # OF POINTS | α | (1 − α) |
|---|---|---|
| 1 | 0.1294 | 0.8706 |
| 5 | 0.3012 | 0.6988 |
| 10 | 0.3810 | 0.6190 |
| 20 | 0.4561 | 0.5439 |
| 50 | 0.5445 | 0.4555 |

It should be noted that the values and corresponding number of points in Table 1 are only one example. The values of a may be selected for various numbers of points based upon a desired weighting between the individual model and the population model that provides the best prediction of location behavior.

In one embodiment, the probability density function map 200 may be generated for each different user of the filtered plurality of social networking messages. The probability density function map 200 may then be used for a variety of applications including, for example, city planning (e.g., where to develop further, where to add public transportation, where to add utilities, and the like) or event detection.

In one embodiment, the population model, the individual model and the probability density function map 200 may be updated continuously as the social networking messages are continuously streaming from the mobile endpoint devices 108-114. In other words, after the initial population model, individual model and the probability density function map 200 are created, new social networking messages that are received may be filtered and added to the filtered plurality of social networking messages to continuously update the models and the probability density function map 200. Thus, the probability values 204 on the probability density function map 200 may also continually be updated and changed as new social networking messages are received and analyzed.

In one embodiment, event detection such as detecting a fraud event, detecting a sports event, detecting a musical event, and the like may be performed using a surprise index value. In one embodiment, the surprise index value may be calculated using Equation (4) below:

Surp(i,(x,y))=log(1/Pᵢ(x,y)), Equation (4):

where Surp(i,(x,y)) represents a surprise index value of an individual i being at a spatial location (x,y) and Pᵢ(x,y) represents a probability of the of the individual being at the spatial location (x,y). In one embodiment, Pᵢ(x,y) may be calculated using Equation (5) below:

Pᵢ(x,y)=area*(α*Model_{D}_{ᵢ}+(1−α)*Model_{D}), Equation (5):

where area represents a spatial area on the map 200 that is being analyzed. For example, area may be a value in square feet, square meters, square yards, square miles, and so forth.

In one embodiment, if the surprise index value is greater than a threshold value then the event may be detected. For example, the probability density function map may be used to detect a fraud event if the surprise index value is greater than 0.50. For example, the individual may live in southern California in region 202 and have a probability of being located in Tucson, Ariz. of only 5% as illustrated by a marker 208 on the map 200. The surprise index value may have a value of 0.85, which is greater than 0.50. Thus, an individual's identity may have been stolen or some other act of fraud based on the surprise index value.

Thus, one embodiment of the present disclosure provides a method to predict location behavior for an individual using a mixture model of an individual model and a population model. The mixture model allows an accurate location behavior prediction to be made for an individual even when the user has sparse or no data at a particular location. The location behavior predictions of individuals may then be used for a variety of applications, for example, city planning, event detection, and the like.

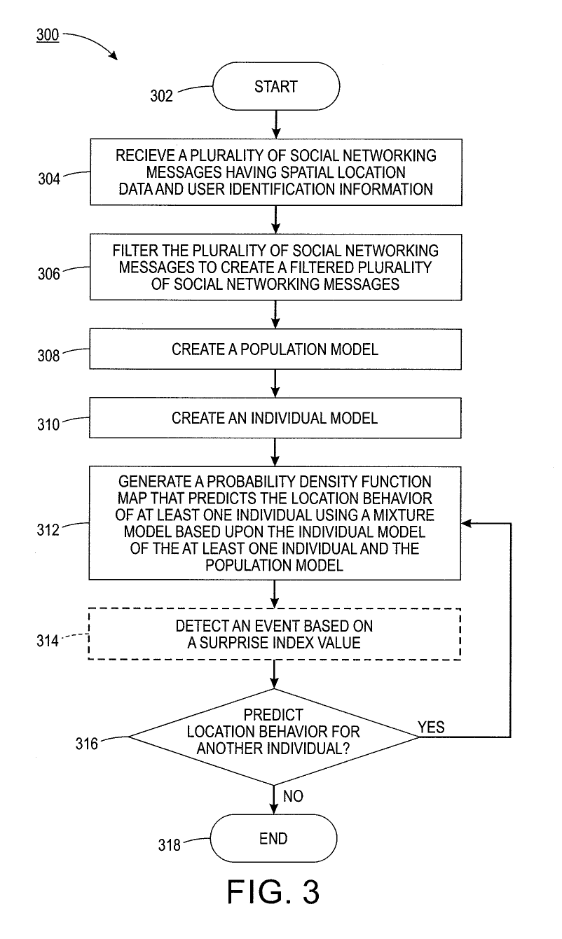

FIG. 3 illustrates a flowchart of a method 300 for predicting a location behavior of at least one individual. In one embodiment, one or more steps or operations of the method 300 may be performed by the AS 104 or a general-purpose computer as illustrated in FIG. 4 and discussed below.

At step 302 the method 300 begins. At step 304, the method 300 receives a plurality of social networking messages having spatial location data and user identification information. In one embodiment, the social networking messages may be, for example, “tweets” transmitted by users that use Twitter®. The spatial coordinate data may include GPS coordinate data (e.g., x, y coordinates of a map or a region). In other words, the spatial coordinate data is not a discrete location (e.g., a one dimensional value that only provides a name of a restaurant or a store, a building, a landmark, and the like) typically used by other methodologies.

At step 306, the method 300 filters the plurality of social networking messages to create a filtered plurality of social networking messages. The filtered plurality of social networking messages may relate to mobility of the users. In other words, the plurality of social networking messages may be filtered to remove one or more of the plurality of social networking messages that are not related to mobility of the user.

In one embodiment, the plurality of social networking messages may be filtered to remove a first one or more of the plurality of social networking messages that are from stationary bots. For example, stationary bots may be from a stationary location that does not represent an individual (e.g., a news cast, a weather report, or other stationary reports).

In one embodiment, the plurality of social networking messages may be filtered to combine a second one or more of the plurality of social networking messages that are from a user within a predefined time period (e.g., within 30 minutes, an hour, and the like) and within a predefined distance (e.g., within 1 mile, 50 meters, and the like). For example, some social networking messages may be part of a conversation between two or more individuals. Thus, these types of social networking messages may be within an hour and within 20 meters of one another. These types of social networking messages do not help capture individual mobility, and therefore, may be combined as a single social networking message within the filtered plurality of social networking messages.

In one embodiment, the plurality of social networking messages may be filtered to remove a third one or more of the plurality of social networking messages that are from a weekend. For example, an assumption may be made that during weekdays mobility patterns of individuals are more observable.

At step 308, the method 300 creates a population model. For example, a kernel density estimation model according to Equation (1) described above may be applied to all of the filtered plurality of social networking messages to create the population model.

At step 310, the method 300 creates an individual model. For example, the kernel density estimation model according to Equation (1) described above may be applied to a subset of the filtered plurality of social networking messages associated with each different user. In other words, the filtered plurality of social networking messages may be separated into subsets of social networking messages for each one of a different plurality of users using the user identification information contained in each one of the social networking messages.

At step 312, the method 300 generates a probability density function map that predicts the location behavior of at least one individual using a mixture model based upon the individual model of the at least one individual and the population model. For example, for a particular individual the mixture model according to Equation (3) described above may be applied to the individual model and the population model to predict a probability of the individual being at a variety of different spatial locations.

At optional step 314, the method 300 may detect an event based on a surprised index value. In one embodiment, the probability density function map may be optionally used for other applications including event detection. For example, the Equation (4) described above may be used to calculate a surprise index value. In one embodiment, when the surprise index value is greater than a threshold value (e.g., 0.50) then an event (e.g., a fraud event such as identity theft) may be detected at a particular location that the individual is located at.

At step 316, the method 300 determines if a prediction of location behavior for another individual is needed. For example, the probability density function map that predicts location behavior of individuals may be generated for additional individuals of the plurality of different individuals or users. If the answer to step 316 is yes, the method 300 may return to step 312. If the answer to step 316 is no, the method 300 may proceed to step 318. At step 318, the method 300 ends.

It should be noted that although not explicitly specified, one or more steps, functions, or operations of the method 300 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 3 that recite a determining operation, or involve a decision, do not necessarily require that both branches of the determining operation be practiced. In other words, one of the branches of the determining operation can be deemed as an optional step.

FIG. 4 depicts a high-level block diagram of a general-purpose computer suitable for use in performing the functions described herein. As depicted in FIG. 4, the system 400 comprises one or more hardware processor elements 402 (e.g., a central processing unit (CPU), a microprocessor, or a multi-core processor), a memory 404, e.g., random access memory (RAM) and/or read only memory (ROM), a module 405 for predicting a location behavior of at least one individual, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the general-purpose computer may employ a plurality of processor elements. Furthermore, although only one general-purpose computer is shown in the figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 405 for predicting a location behavior of at least one individual (e.g., a software program comprising computer-executable instructions) can be loaded into memory 404 and executed by hardware processor element 402 to implement the steps, functions or operations as discussed above in connection with the exemplary method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for predicting a location behavior of at least one individual (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for predicting a location behavior of at least one individual, comprising:
receiving, by a processor, a plurality of social networking messages having spatial location data and user identification information;
filtering, by the processor, the plurality of social networking messages to create a filtered plurality of social networking messages related to mobility of users;
creating, by the processor, a population model by applying a kernel density estimation to the filtered plurality of social networking messages;
creating, by the processor, an individual model for each different user identification by applying the kernel density estimation to a subset of the filtered plurality of social networking messages for the each different user identification; and
generating, by the processor, a probability density function map that predicts the location behavior of the at least one individual using a mixture model based upon the individual model of the at least one individual and the population model.

2. The method of claim 1, wherein the at least one individual comprises a group of individuals.

3. The method of claim 1, wherein the spatial location data comprises global positioning system (GPS) coordinates.

4. The method of claim 1, wherein the filtering comprises:
removing, by the processor, a first one or more of the plurality of social networking messages that are from stationary bots;
combining, by the processor, a second one or more of the plurality of social networking messages that are from a user within a predefined time period and within a predefined distance; and
removing, by the processor, a third one or more of the plurality of social networking messages that are from a weekend.

5. The method of claim 1, wherein the kernel density estimation function is calculated in accordance with a first equation:
$$pdf ( x ) = \frac{1}{n} {\sum }_{i = 1}^{n} {K}_{H} ( x - {x}_{i} ) , n = \vert D \vert , \qquad$$
wherein pdf(x) is a probability density function of a location vector x comprising (x,y) coordinates, K_{H} is a kernel function of the location vector x and an individual location vector xᵢ and |D| is a total number of the filtered plurality of social networking messages.

6. The method of claim 5, wherein the kernel function K_{H} is calculated in accordance with a second equation:
$${K}_{H} ( x ) = {\vert H \vert}^{- 0.5} * {( 2 π )}^{- \frac{d}{2}} {e}^{- \frac{1}{2} {x}^{T} {H}^{- 0.5} x} , \qquad$$
wherein H represents a bandwidth on each dimension, d, of a density of each training data point and T represents a transpose function.

7. The method of claim 6, wherein H is a diagonal matrix with diagonal values of 0:001.

8. The method of claim 1, wherein mixture model comprises an equation:
pdf(xᵢ)=α*Model_{D}_{ᵢ}+(1−α)*Model_{D},
wherein α is a value that varies based upon a number of filtered social networking messages available for an individual, Model_{D}_{ᵢ} represents the individual model created by the kernel density estimation and Model_{D} represents the population model created by the kernel density estimation.

9. The method of claim 1, further comprising:
calculating, by the processor, a surprise index value based upon a comparison of a location of the at least one individual determined from a new social networking message and a probability that the at least one individual is at the location obtained from the probability density function map of the at least one individual.

10. The method of claim 9, further comprising:
detecting, by the processor, an event based on the surprise index value exceeding a threshold value.

11. The method of claim 10, wherein the event comprises a fraud event.

12. A non-transitory computer-readable medium storing a plurality of instructions which, when executed by a processor, cause the processor to perform operations for predicting a location behavior of at least one individual, the operations comprising:
receiving a plurality of social networking messages having spatial location data and user identification information;
filtering the plurality of social networking messages to remove one or more of the plurality of social networking messages that are not related to mobility of a user to create a filtered plurality of social networking messages;
creating a population model by applying a kernel density estimation to the filtered plurality of social networking messages;
creating an individual model for each different user identification by applying the kernel density estimation to a subset of the filtered plurality of social networking messages for the each different user identification; and
generating a probability density function map that predicts the location behavior of the at least one individual using a mixture model based upon the individual model of the at least one individual and the population model.

13. The non-transitory computer-readable medium of claim 12, wherein the filtering comprises:
removing a first one or more of the plurality of social networking messages that are from stationary bots;
combining a second one or more of the plurality of social networking messages that are from a user within a predefined time period and within a predefined distance; and
removing a third one or more of the plurality of social networking messages that are from a weekend.

14. The non-transitory computer-readable medium of claim 12, wherein the kernel density estimation function is calculated in accordance with a first equation:
$$pdf ( x ) = \frac{1}{n} {\sum }_{i = 1}^{n} {K}_{H} ( x - {x}_{i} ) , n = \vert D \vert , \qquad$$
wherein pdf(x) is a probability density function of a location vector x comprising (x,y) coordinates, K_{H} is a kernel function of the location vector x and an individual location vector xᵢ and |D| is a total number of the filtered plurality of social networking messages.

15. The non-transitory computer-readable medium of claim 14, wherein the kernel function K_{H} is calculated in accordance with a second equation:
$${K}_{H} ( x ) = {\vert H \vert}^{- 0.5} * {( 2 π )}^{- \frac{d}{2}} {e}^{- \frac{1}{2} {x}^{T} {H}^{- 0.5} x} ,$$
wherein H represents a bandwidth on each dimension, d, of a density of each training data point and T represents a transpose function.

16. The non-transitory computer-readable medium of claim 15, wherein H is a diagonal matrix with diagonal values of 0:001.

17. The non-transitory computer-readable medium of claim 12, wherein mixture model comprises an equation:
pdf(xᵢ)=α*Model_{D}_{ᵢ}+(1−α)*Model_{D},
wherein α is a value that varies based upon a number of filtered social networking messages available for an individual, Model_{D}_{ᵢ} represents the individual model created by the kernel density estimation and Model_{D} represents the population model created by the kernel density estimation.

18. The non-transitory computer-readable medium of claim 12, further comprising:
calculating a surprise index value based upon a comparison of a location of the at least one individual determined from a new social networking message and a probability that the at least one individual is at the location obtained from the probability density function map of the at least one individual.

19. The non-transitory computer-readable medium of claim 12, further comprising:
detecting an event based on the surprise index value exceeding a threshold value.

20. A method for predicting a location behavior of at least one individual, comprising:
receiving, by a processor, a plurality of social networking messages within a region having global positioning satellite coordinates and user identification information;
filtering, by the processor, the plurality of social networking messages to remove one or more of the plurality of social networking messages that are not related to mobility of a user to create a filtered plurality of social networking messages;
creating, by the processor, a population model by applying a kernel density estimation to the filtered plurality of social networking messages;
creating, by the processor, an individual model for each different user identification by applying the kernel density estimation to a subset of the filtered plurality of social networking messages for the each different user identification; and
generating, by the processor, a probability density function map that predicts the location behavior of the at least one individual as a percentage value in a plurality of different locations within the region and outside of the region using a mixture model based upon the individual model of the at least one individual and the population model, wherein the mixture model weights the population model greater as a number of data points used for the individual model decreases.
